(19) United States
(12) Patent Application Publication
(10) Pub. No.: US 2013/0333142 A1
(43) Pub. Date: Dec. 19, 2013

(54) DECORATIVE ATTACHMENT FOR WINDSHIELD WIPER ASSEMBLY

(71) Applicant: Michael Keith SHENK, North Potomac, MD (US)

(72) Inventor: Michael Keith SHENK, North Potomac, MD (US)

(21) Appl. No.: 13/791,253

(22) Filed: Mar. 8, 2013

Related U.S. Application Data
(60) Provisional application No. 61/608,841, filed on Mar. 9, 2012.

(51) Int. Cl. B60S 1/04

(52) U.S. Cl. CPC B60S 1/0491
USPC 15/250.32

(57) ABSTRACT

A windshield wiper decorative device for detachably securing to the wiper arm of a windshield wiper, comprises a planar display element having a central planar surface circumscribed by a lip. A pair of fastening tangs extend from a back of the planar display element, each of the tangs having a respective aperture passing therethrough. A pair of flexible ties extends through the respective aperture for detachably securing the planar display element to a windshield wiper arm. When secured to the windshield wiper arm, the planar display element lies adjacent the windshield wiper arm and the flexible ties extend around the windshield wiper arm and secure the planar display element to the windshield wiper arm.

### FIELD OF THE INVENTION

The present invention relates to movable decorative attachments in general and, more particularly, to a decorative attachment for a windshield wiper assembly of a motor vehicle so that pivotal movement of the windshield wiper assembly produces wavering motion of the decorative attachment.

### DESCRIPTION OF THE PRIOR ART

In modern vehicles, larger vehicles such as SUVs, vans and station wagons have a liftgate or rear hatch which closes a rear opening in the vehicle body. The liftgate is pivotally attached, usually by hinges, to the vehicle body structure surrounding the rear opening. The liftgate is releasably lockable to the vehicle body by a latch mechanism so as to be movable between a closed position latched to the vehicle body structure and a pivoted, open position allowing access to the interior of the vehicle through the rear opening. Typically, the liftgate of the motor vehicle is provided with a windshield wiper assembly.

Currently, decorative attachments exist for a windshield wiper assembly of a motor vehicle. While these decorative attachments may be suitable for the particular purpose, they nevertheless are susceptible to improvements that enhance their ease of use and advance the art.

### BRIEF DESCRIPTION OF THE DRAWINGS

Other objects and advantages of the invention will become apparent from a study of the following specification when viewed in light of the accompanying drawings, wherein:

FIG. 1 is a plan view of a decorative attachment according to a first exemplary embodiment of the present invention in combination with a liftgate of a motor vehicle;

FIG. 2 is a perspective view of the liftgate of the motor vehicle with a conventional windshield wiper assembly;

FIG. 3 is a side view of a conventional wiper blade assembly;

FIG. 4 is a front view of the decorative attachment according to the first exemplary embodiment of the present invention;

FIG. 5 is a rear view of the decorative attachment according to the first exemplary embodiment of the present invention;

FIG. 6 is a side view of the decorative attachment according to the first exemplary embodiment of the present invention;

FIG. 7 is a plan view of a decorative attachment according to a second exemplary embodiment of the present invention in combination with the liftgate of the motor vehicle;

FIG. 8 is a front view of the decorative attachment according to the second exemplary embodiment of the present invention;

FIG. 9 is a rear view of the decorative attachment according to the second exemplary embodiment of the present invention;

FIG. 10 is a vertical cross-sectional view of the decorative attachment according to the first exemplary embodiment of the present invention taken along the lines 10-10 in FIG. 9;

FIGS. 11a-11d illustrate an exemplary embodiment of the invention;

FIGS. 12a-12d illustrate a modified version of the embodiment shown in FIGS. 11a-11d;

FIGS. 13a-13e illustrate another exemplary embodiment of the invention.

### DESCRIPTION OF PREFERRED EMBODIMENTS

The exemplary embodiments of the present invention will now be described with the reference to accompanying drawings.

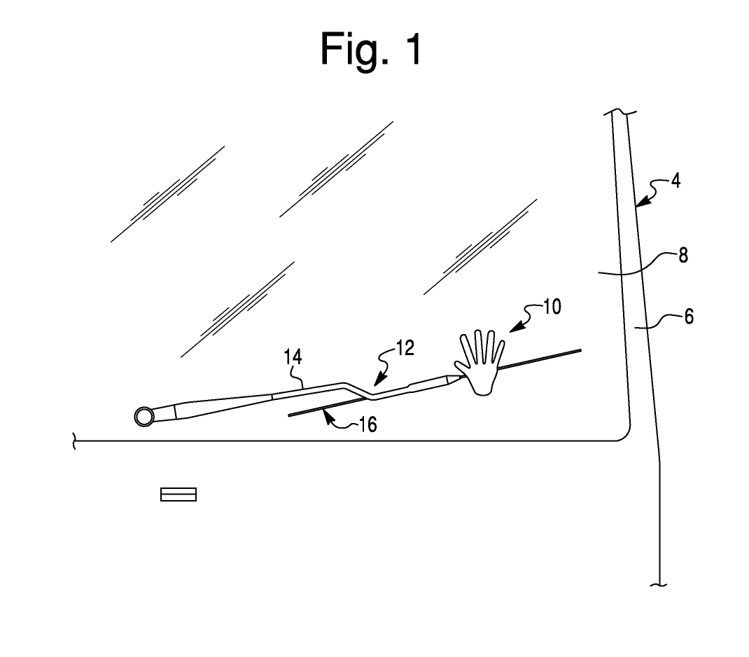

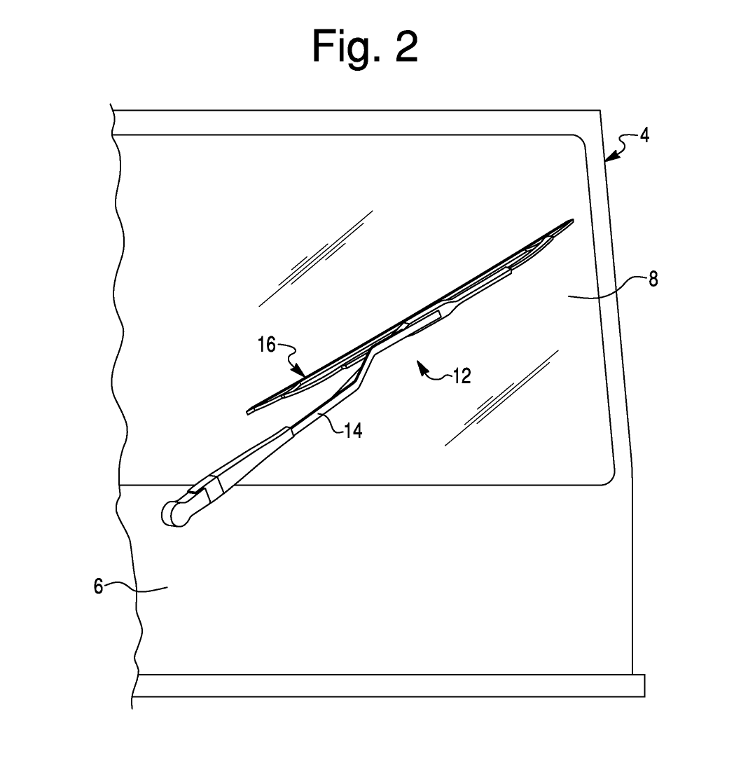

FIG. 1 depicts a decorative attachment (generally denoted by reference numeral 10) according to a first exemplary embodiment of the present invention. The decorative attachment 10 is mounted to a conventional windshield wiper assembly 12 of a motor vehicle 4 illustrated in FIG. 2. The decorative attachment 10 according to the present invention is especially applicable to the windshield wiper assembly 12 of a rear liftgate 6 of the motor vehicle 4, such as SUV, CUV, station wagon, fastback, and etc., having a vehicle liftgate window 8 carried on the liftgate 6 and the rear mounted wiper assembly 12 mounted on the liftgate 6, as shown in FIGS. 1 and 2.

The conventional rear windshield wiper assembly 12 includes a conventional wiper arm 14 and a conventional wiper blade assembly 16 attached to the wiper arm 14.

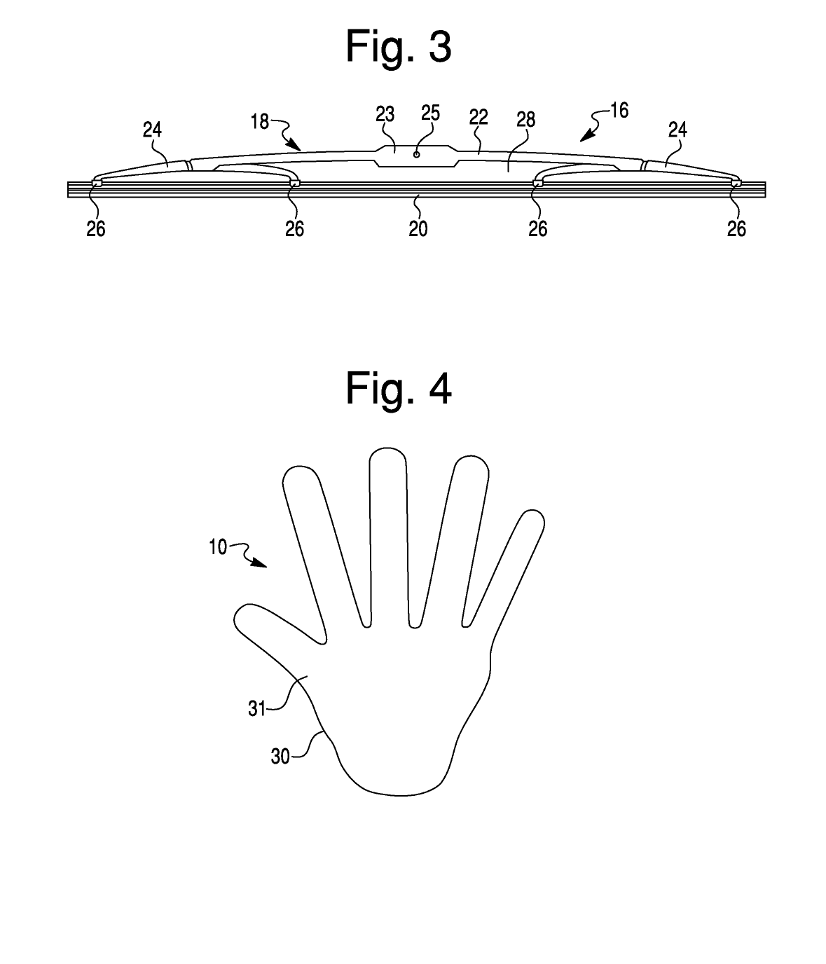

As best shown in FIG. 3, the conventional wiper blade assembly 16 comprises a multi-part frame 18 carrying an elongated rubber wiper strip 20. The frame 18 includes a main bracket (or main yoke) 22 engaging at the opposite ends thereof claw brackets (or secondary yokes) 24 arranged on its ends. The wiper strip 20 is located vertically under the caw brackets 24 and is engaged by claws 26 arranged at the ends of the claw brackets 24. The claws 26 engage the wiper strip 20 and extend into longitudinal grooves provided opposite to one another in a rear region of the wiper strip 20. Moreover, the main bracket 22 in a central region thereof is provided with an attachment portion 23 carrying a transverse pivot pin 25 for attaching the wiper blade assembly 16 to the wiper arm 14 for driving the wiper blade assembly 16 across the liftgate window 8.

As further illustrated in FIG. 3, the wiper blade assembly 16 has a through opening 28 provided between the wiper strip 20 and the main bracket 22.

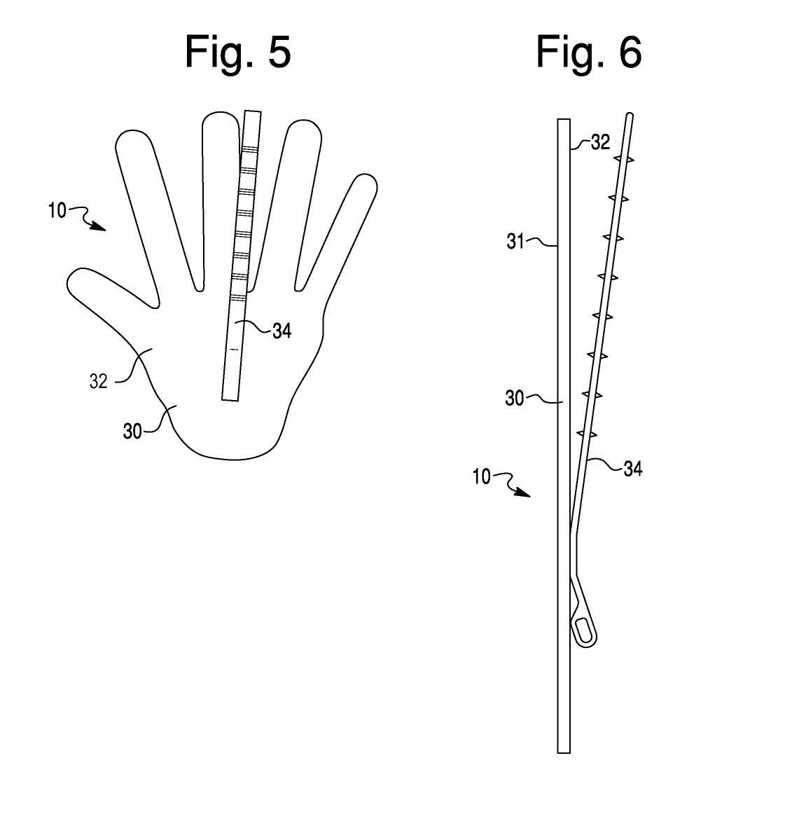

The decorative attachment 10, according to the first exemplary embodiment of the present invention, the best illustrated in FIGS. 4-6, includes a flat display element 30 having an outer (visible from the outside) surface 31 and an inner (not visible from the outside) surface 32 opposite to the outer surface 31, and an attachment element 34 adhesively affixed to the inner surface 32 of the display element 30 as best seen in FIGS. 5 and 6. The attachment element 34 is provided to couple the display element 30 of the decorative attachment 10 to the wiper blade assembly 16.

The display element 12 according to the exemplary embodiments of the present invention is in a shape of a hand and is formed of sheet rigid plastic material. Alternatively, any other appropriate rigid or semi-rigid light-weight weather resistant material is within the scope of the present invention. Further alternatively, the display element 12 may have any other appropriate decorative shape. Moreover, a viewable indicia or graphics may be provided (such as by printing) on the outer surface 31 of the flat display element 30. The viewable indicia or graphics may be in the form of words, emblems and logos associated with businesses, college or professional athletic team logos and emblems, schools and the like.

According to the first exemplary embodiments of the present invention, the attachment element 34 is in the form of a zip-tie, portion of which is adhesively bonded to the inner surface 32 of the display element 30 as best seen in FIGS. 5 and 6. As illustrated in FIG. 1, the display element 30 of the decorative attachment 10 is secured to the wiper blade assembly 16 by passing the zip-tie 34 through the opening 28 between the wiper strip 20 and the main bracket 22 of the wiper blade assembly 16, thus attaching the decorative attachment 10 to the frame of the wiper blade assembly 16. It will be appreciated that any other appropriate attachment devices, such mating Velcro straps, spring biased clips, clamps and other releasable attachment devices, are within the scope of the present invention.

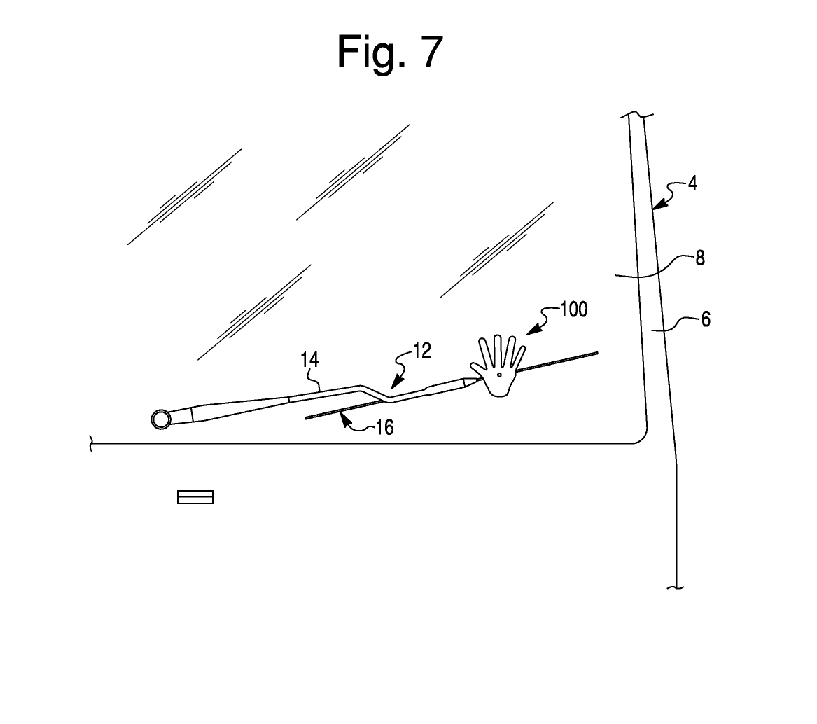

FIG. 7 depicts a decorative attachment (generally denoted by reference numeral 100) according to a second exemplary embodiment of the present invention. Similarly to the first exemplary embodiment of the present invention, the decorative attachment 100 is mounted to the windshield wiper assembly 12 of the motor vehicle 4.

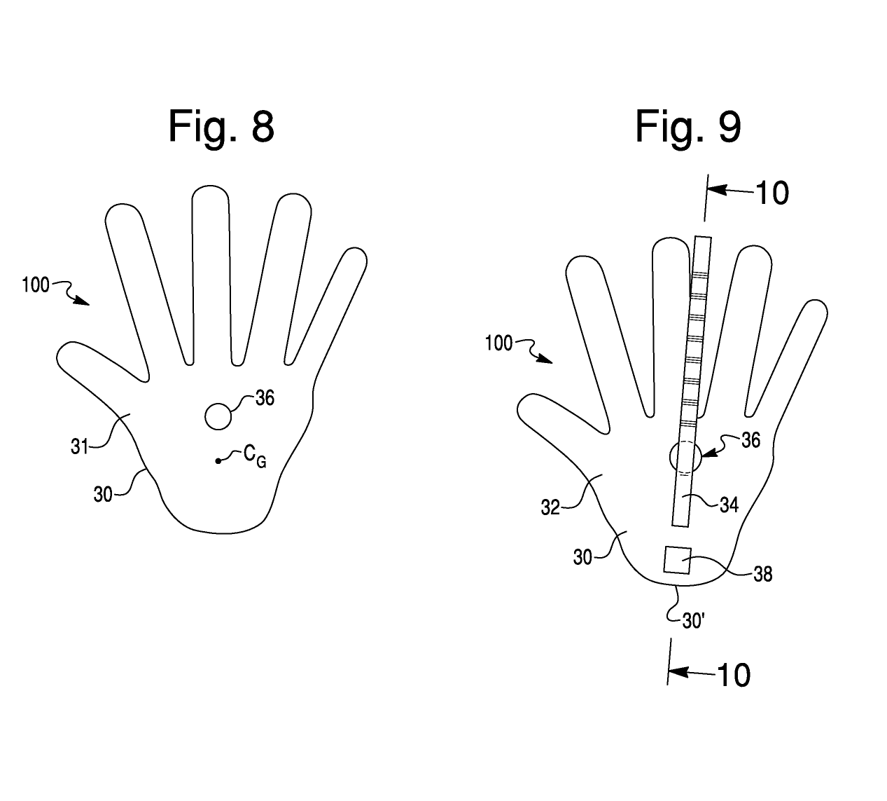

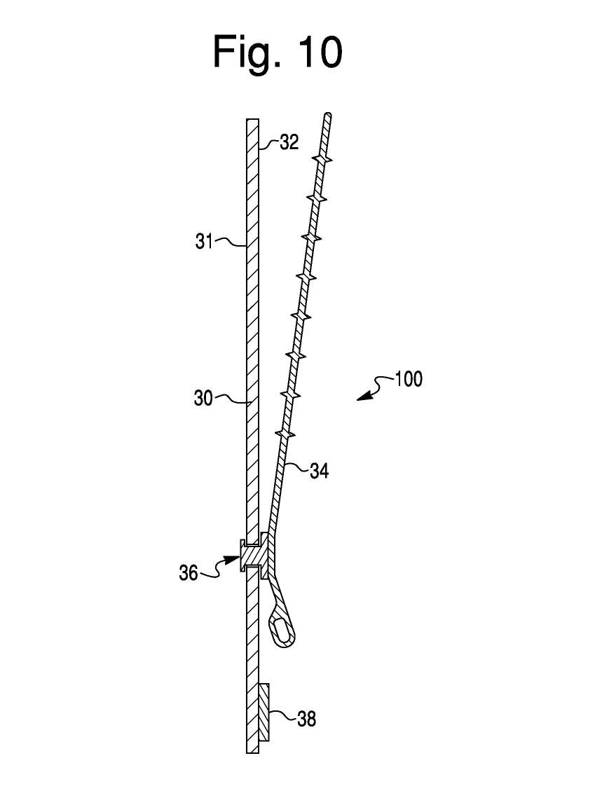

The decorative attachment 100, according to the second exemplary embodiment of the present invention, the best illustrated in FIGS. 8-10, includes a flat display element 30 having an outer (visible from the outside) surface 31 and an inner (not visible from the outside) surface 32 opposite to the outer surface 31, a floating pin member 36 rotatably coupled to the display element 30 and extending therethrough, and an attachment element 34 adhesively affixed to the pin member 36 as best seen in FIGS. 9 and 10. The pin member 36 allows the display element 30 to be rotatable relative to the attachment element 34. Moreover, the pin member 36 is extending through the display element 30 in a position above a center of gravity C_{G} of the display element 30. As a result, the display element 30 is always oriented substantially vertically irrespective of the position of the windshield wiper assembly 12 relative to the liftgate window 8 of the liftgate 6 during the pivotal movement of the windshield wiper assembly 12. The decorative attachment 100, according to the second exemplary embodiment of the present invention, further comprises a weight member 38 adhesively bonded to the inner surface 32 of the display element 30 below the pin member 36 and adjacent to a lower edge 30′ of the display element 30 so as to shift the center of gravity C_{G} of the display element 30 further away from the pin member 36.

The attachment element 34 is provided to couple the display element 30 of the decorative attachment 10 to the wiper arm 14 or the wiper blade assembly 16 of the windshield wiper assembly 12.

Similarly to the first exemplary embodiment of the present invention, the display element 12 is in a shape of a hand and is formed of sheet rigid plastic material. Alternatively, any other appropriate rigid or semi-rigid light-weight weather resistant material is within the scope of the present invention. Further alternatively, the display element 12 may have any other appropriate decorative shape. Moreover, a viewable indicia may be provided (such as by printing) on the outer surface 31 of the flat display element 30. The viewable indicia may be in the form of words, emblems and logos associated with businesses, college or professional athletic team logos and emblems, schools and the like.

According to the second exemplary embodiments of the present invention, the attachment element 34 is in the form of a zip-tie, portion of which is adhesively bonded to the inner surface 32 of the display element 30 as best seen in FIGS. 9 and 10. As illustrated in FIG. 7, the display element 30 of the decorative attachment 100 is secured to the wiper blade assembly 16 by passing the zip-tie 34 through the opening 28 between the wiper strip 20 and the main bracket 22 of the wiper blade assembly 16, thus attaching the decorative attachment 10 to the frame of the wiper blade assembly 16. It will be appreciated that any other appropriate attachment devices, such mating Velcro straps, spring biased clips, clamps and other releasable attachment devices, are within the scope of the present invention.

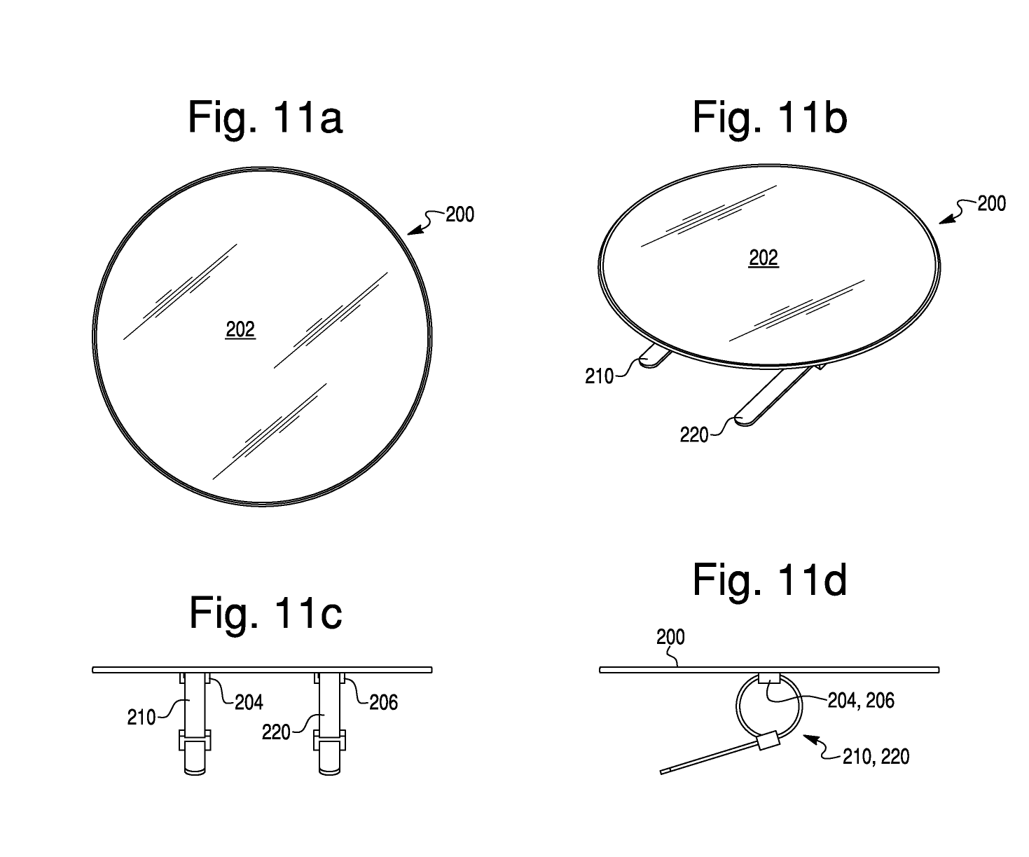

FIG. 11a illustrates an exemplary embodiment of the invention in the form of round, flat display element 200 having a display surface 202 adapted to receive any viewable indicia or graphics which may be provided (such as by printing) on the surface 202 of the flat display element 200. The viewable indicia or graphics may be in the form of words, emblems and logos associated with businesses, college or professional athletic team logos and emblems, schools and the like. FIG. 11b illustrates an isometric view of the display element 200 having attachment devices 210, 220 in the form of straps or flexible ties which pass through openings 204, 206 formed in the display element. The ties 210, 220 provide an adjustable mounting system for different sized wiper arms.

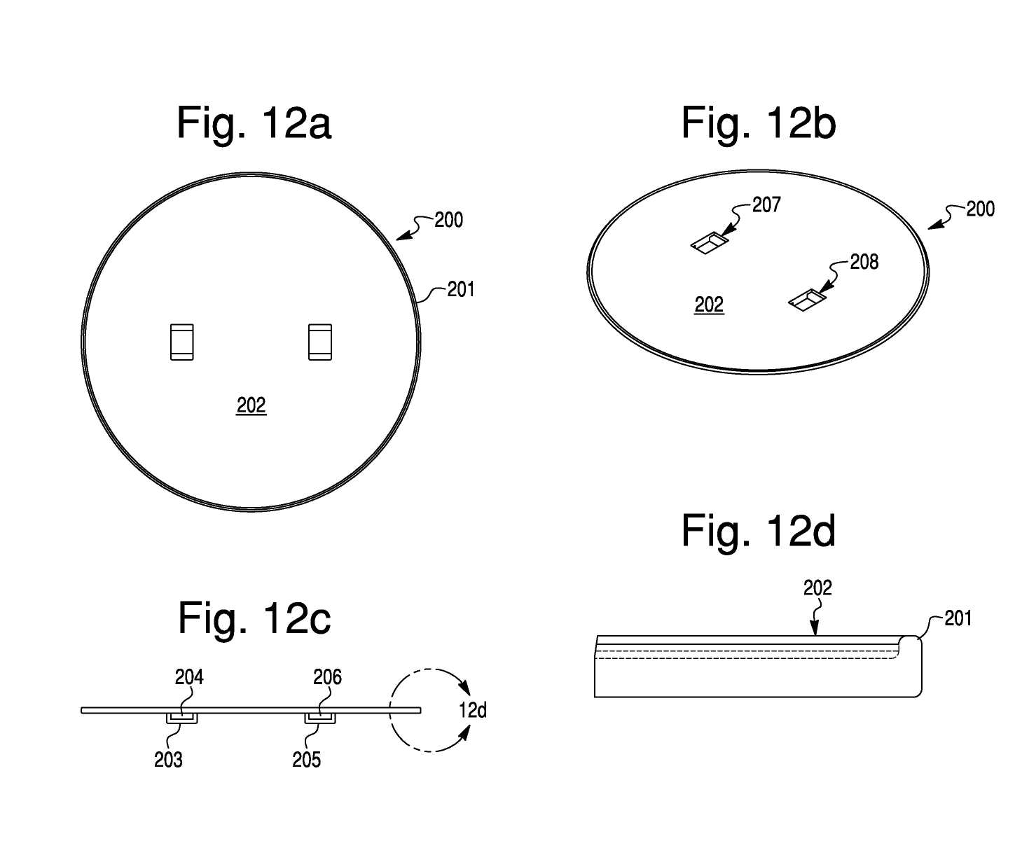

FIG. 12a illustrates a modified design of the display element of FIG. 11a whereby tangs 203, 205 are formed into the display element 200 to include the tie-receiving opening 204, 206. In the design of FIGS. 12a-12c, the tangs 203, 205 are formed to create apertures 207, 208 in the central planar surface 202 of the display element 200. The aperture 207, 208 improve the aerodynamic properties of the display element 200 when mounted on the wiper arm of a moving vehicle.

Additionally, the display element is formed with a peripheral lip 201 circumscribing the central planar surface 202 to provide a recessed surface 202 to receive a decal, label or other mountable design element (not shown) which fits into the recess formed by the lip 201.

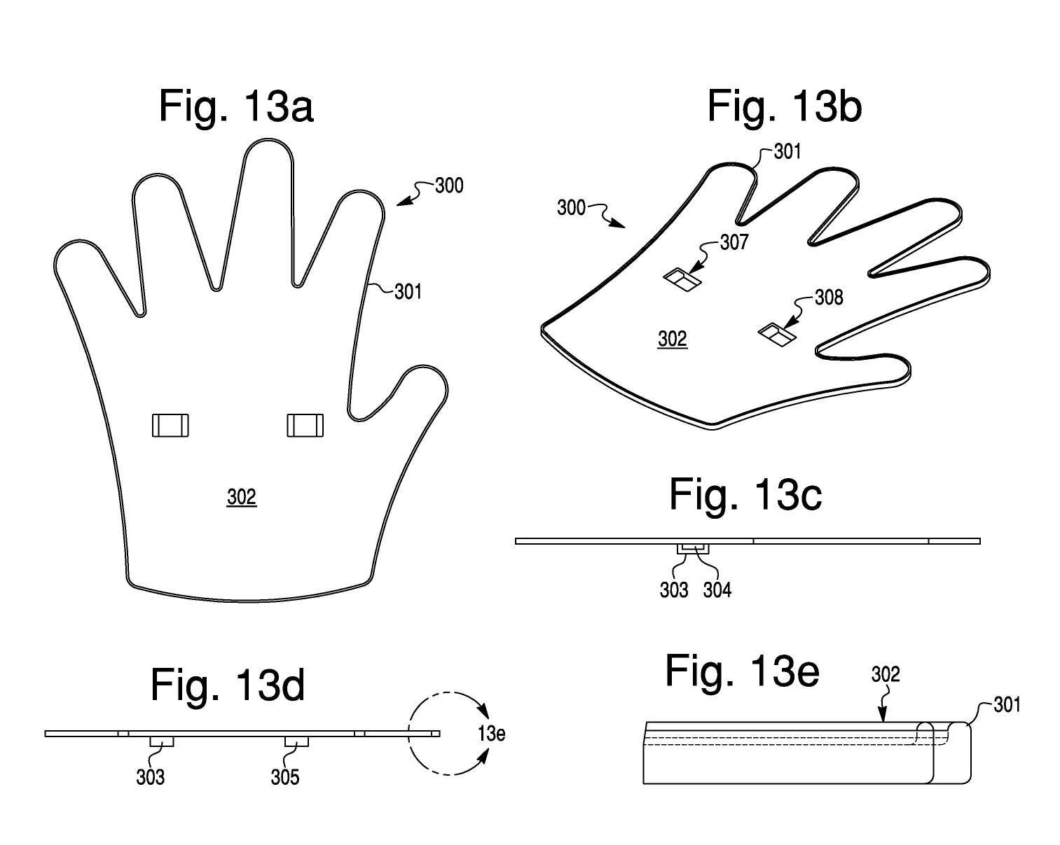

FIG. 13a illustrates another modified design of the display element 300 of FIG. 11a with the display element is formed in the shape of a hand. Tangs 303, 305 are formed into the display element 300 to include the tie-receiving opening 304, 206 (see FIG. 13c). In the design of FIGS. 13a-13d, the tangs 303, 305 are formed to create apertures 307, 308 (see FIG. 13b) in the central planar surface 302 of the display element 300. The aperture 307, 308 improve the aerodynamic properties of the display element 300 when mounted on the wiper arm of a moving vehicle. The tangs 303, 305 for fastening the display element 300 to the wiper arm may be rearranged, for example by 90 degrees to be aligned with the length of the hand, to alter the orientation of the display element 300 with respect to the wiper arm.

Additionally, the display element 300 of FIGS. 13a-13e is formed with a peripheral lip 301 circumscribing the central planar surface 302 to provide a recessed surface 202 to receive a decal, label or other mountable design element (not shown) which fits into the recess formed by the lip 301.

Therefore, the present invention provides a novel decorative attachment for a windshield wiper assembly of a motor vehicle.

The foregoing description of the exemplary embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

1. A windshield wiper decorative device for detachably securing to the wiper arm of a windshield wiper, comprising:
a windshield wiper arm;
a planar display element having a central planar surface;
a pair of fastening tangs extending from a back of said planar display element, each of said tangs having a respective aperture passing therethrough;
a pair of flexible ties extending through said respective aperture for detachably securing the planar display element to the windshield wiper arm; and
wherein when secured to the windshield wiper arm the planar display element lies adjacent the windshield wiper arm and the flexible ties extend around the windshield wiper arm and secure the planar display element to the windshield wiper arm.

2. The windshield wiper decorative device of claim 1, wherein planar display element further comprises a peripheral lip defining a recessed surface for said central planar surface, wherein said lip is raised above said recessed surface.

3. The windshield wiper decorative device of claim 1, wherein the planar display element includes a plurality of apertures passing through said central planar surface.

4. The windshield wiper decorative device of claim 1, wherein the planar display element includes a pair of apertures passing through said central planar surface, said apertures being aligned with said tangs.

5. The windshield wiper decorative device of claim 1, wherein the planar display element and tangs are of an integral molded plastic construction.

6. The windshield wiper decorative device of claim 1, further including a weight member selectively positioned on said planar display element to act as a counterbalance member.

7. A windshield wiper decorative device for detachably securing to the wiper arm of a windshield wiper, comprising:
a windshield wiper arm;
a planar display element having a central planar surface, said planar display element comprises a peripheral lip defining a recessed surface for said central planar surface, wherein said lip is raised above said recessed surface;
a pair of fastening tangs extending from a back of said planar display element, each of said tangs having a respective aperture passing therethrough;
a pair of flexible ties extending through said respective aperture for detachably securing the planar display element to the windshield wiper arm; and
wherein when secured to the windshield wiper arm the flexible ties extend around the windshield wiper arm and secure the planar display element to the windshield wiper arm.
